(19) United States
(12) Patent Application Publication
(10) Pub. No.: US 2026/0309291 A1
(43) Pub. Date: Oct. 8, 2026

(54) Stage light fixture having multi-colored zone effect element

(71) Applicant: Guangzhou Haoyang Electronic Co., Ltd., Guangzhou (CN)

(72) Inventors: Weikai JIANG, Guangzhou (CN); Wenzhong QIU, Guangzhou (CN); Xindong LIU, Guangzhou (CN)

(21) Appl. No.: 19/465,707

(22) Filed: Jan. 30, 2026

(30) Foreign Application Priority Data
Apr. 8, 2025 (CN) 202520653649.7

(51) Int. Cl. F21S 10/00; F21V 14/08; F21W 131/406

(52) U.S. Cl. CPC F21S 10/007; F21V 14/08; F21W 2131/406

(57) ABSTRACT

A stage light fixture having a multi-colored zone effect element includes a light head, which is provided with a light source for emitting a light beam along a light path, and a color wheel and a light output lens arranged sequentially along an emission direction of the light beam. The color wheel is provided with a multi-colored zone element having a plurality of colored zones, with adjacent colored zones in gapless connection, and the color wheel is driven by a first drive assembly to allow at least one colored zone of the multi-colored zone element to selectively switch into/out of the light beam.

### CROSS REFERENCE TO RELATED APPLICATIONS

The present disclosure claims priority from Chinese Application No. CN 202520653649.7 filed on Apr. 8, 2025, all of which are hereby incorporated herein by reference.

### TECHNICAL FIELD

The present disclosure relates to the technical field of stage light fixtures, and more particularly, to a stage light fixture having a multi-colored zone effect element.

### BACKGROUND

In the prior art, stage light fixtures are often used to build performance effects and create a colorful beam atmosphere. The colorful light spots projected by the light fixture are primarily achieved by color filters. With the increasingly complex performance scenarios and the increasing demand for lighting color effects, monochromatic color filters are difficult to meet the needs. Existing color wheels can only support a plurality of monochromatic color filters. In such configuration, a gap is inevitably formed when one color filter is switched into another one, which results in unsatisfactory projection effects due to a brief blank color effect.

### SUMMARY OF THE DISCLOSURE

It is therefore an object of the present disclosure to provide an improved light fixture having a multi-colored zone effect element.

The stage light fixture in the present disclosure includes a light head. The light head is provided with a light source for generating a light beam along a light path, and a color wheel and a light output lens arranged sequentially along an emission direction of the light beam. The color wheel includes a multi-colored zone element having a plurality of colored zones, with adjacent colored zones in gapless connection. A first drive assembly is further included for driving the color wheel to move, so as to allow at least one colored zone on the multi-colored zone element to selectively switch into/out of the light beam.

In the present disclosure, the multi-colored zone element is provided with a plurality of colored zones, so that several colored zones can be simultaneously switched into the light beam to generate colorful light spots. Furthermore, due to the adjacent colored zones in gapless connection, the final projected light spots can present multiple colors without any gaps between different colored zones, so that even magnified projection will not cause abrupt transition and reduction in the aesthetic feeling of the light spot effect. In addition, the color wheel can be driven by the first drive assembly to switch into/out of the light beam. Therefore, the colored zones on the multi-colored zone element can be selectively switched into/out of the light beam, which further increases color arrangement of the projected light spots.

In order to allow one light spot to simultaneously present multiple colors, the multi-colored zone element may be configured to allow at least two of the colored zones to be always simultaneously located in the light beam, when completely intercepting the light beam, according to a preferable embodiment of the present disclosure. This increases the color richness of the light spots.

According to a preferable embodiment of the present disclosure, the multi-colored zone element may contain 6 colors, which can increase color selectivity for the light spots.

In a particular embodiment of the present disclosure, the multi-colored zone element includes at least two transparent substrates stacked on top of one another and a color coating layer positioned on at least one side of each of the transparent substrates.

Considering distinct color contrast between three primary colors, which can give the audience a strong visual impact, the color of each color coating layer may be preferably one of cyan, magenta, and yellow, or one of red, green, and blue. The three primary colors of cyan, magenta, and yellow are based on subtractive color mixing, and the three primary colors of red, green, and blue are based on additive color mixing.

It is required to make the final color, caused by superposition of the color coating layers, precisely controllable. According to a preferable embodiment of the present disclosure, in the emission direction of the light beam, at most two color coating layers overlap simultaneously. This avoids unpredictable colors caused by superposition of too many color coating layers, and simplifies color design and adjustment/replacement.

Furthermore, one color coating layer may partially overlap with other color coating layer. That is, the other part of the color coating layer does not overlap with any other color coating layer, i.e., it overlaps directly with the transparent substrate. This configuration can retain original color as possible, providing a stronger visual impact.

To reduce the number of transparent substrates and thus reduce the thickness of the multi-colored zone element, the transparent substrates may be provided with the color coating layer on each side along the emission direction of the light beam. This allows the color separations to be clearly imaged.

In a further particular embodiment of the present disclosure, the multi-colored zone element particularly may include three stacked transparent substrates, and only one side of each transparent substrate may be provided with the color coating layer. The stacking thickness of the three transparent substrates is appropriate, and sufficient colors can be achieved.

As adhesive bonding can prevent water ripples (interference fringes), adjacent transparent substrates may be fixed by adhesively bonding edges with adhesive. This can effectively avoid the influence of adhesive on the light beam, resulting in better light efficiency.

According to a more preferable embodiment of the present disclosure, in order to achieve more color arrangement and obtain richer colors, a plurality of multi-colored zone elements may be provided, and the first drive assembly may be configured to selectively drive one of the multi-colored zone elements to switch into the light beam. The plurality of multi-colored zone elements in this case can be driven by the first drive assembly to switch into the light beam according to actual demands.

Alternatively, each multi-colored zone element may be assigned with one first drive assembly for separately switching the corresponding multi-colored zone element into/out of the light beam.

Furthermore, at least two multi-colored zone elements may be simultaneously switched into the light beam, with the colored zones of each of the multi-colored zone elements at least partially overlapped.

In addition, the multi-colored zone elements may be arranged coaxially, which may be driven to rotate by the corresponding first drive assembly to switch into/out of the light beam

Additionally, the color wheel may further include a gradient color filter, and the first drive assembly may be configured to selectively drive the multi-colored zone element or the gradient color filter to switch into the light beam. With the combination of the multi-colored zone element and the gradient color filter, more color effect interpretation can be provided during performance according to actual demands.

A pattern effect element may be further included in the emission direction of the light beam in a preferable embodiment, which may be driven by a second drive assembly to switch into/out of the light beam to generate a superimposed light effect cooperated with the multi-colored zone element. This configuration can generate a pattern effect with multiple colors, thereby forming more vivid pattern light spots.

### BRIEF DESCRIPTION OF THE DRAWINGS

FIG. 1 is a perspective view of a light head according to an embodiment of the present disclosure, with some parts omitted.

FIG. 2 is a perspective view of a multi-colored zone element according to an embodiment of the present disclosure.

FIG. 3 is an exploded view of the multi-colored zone element of FIG. 2.

FIG. 4 is a disassembly view of a pattern effect element, a color wheel, and a first drive assembly according to an embodiment of the present disclosure.

### DETAILED DESCRIPTION OF EMBODIMENTS

The drawings are for illustrative purposes only and should not be construed as limiting the present disclosure. For better illustration of this embodiment, some parts in the drawings may be omitted, enlarged, or reduced, and do not represent the size of the actual product. It is understandable to those skilled in the art that certain known structures and their descriptions in the drawings may be omitted. The positional relationships described in the drawings are for illustrative purposes only and should not be construed as limiting the present disclosure.

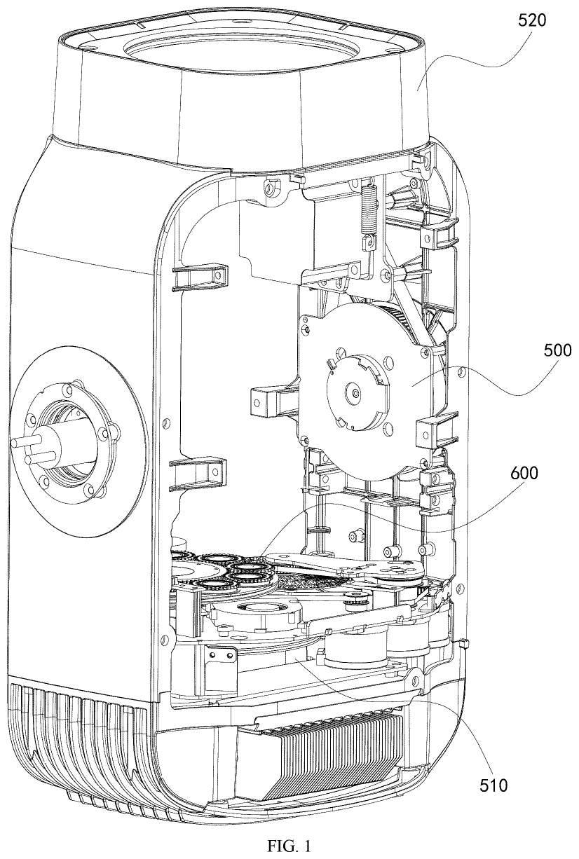

A stage light fixture having a multi-colored zone effect element is provided according to an embodiment of the present disclosure. The stage light fixture in the present embodiment includes a light head 500. The light fixture may also include a support arm (not shown) pivotally connected to the light head 500. As shown in FIG. 1, the light head 500 is provided with a light source 510 for generating a light beam along a light path, and a color wheel and a light output lens 520 arranged sequentially along an emission direction of the light beam. The color wheel includes a multi-colored zone element 100 having a plurality of colored zones, with adjacent colored zones in gapless connection. A first drive assembly 530 is further provided for driving the color wheel to move, so as to drive at least one of the colored zones of the multi-colored zone element 100 to selectively switch into/out of the light beam.

With the configuration of the multi-colored zone element 100 with a plurality of colored zones, several colored zones can be simultaneously switched into the light beam to generate colorful light spots. Furthermore, due to the adjacent colored zones in gapless connection, the final projected light spots can present multiple colors without any gaps between different colored zones, so that even magnified projection will not cause abrupt transition and reduction in the aesthetic feeling of the light spot effect. With the first drive assembly 530, the colored zones of the multi-colored zone element 100 can be selectively switched into/out of the light beam, which further increases color arrangement of the projected light spots.

According to the present embodiment, at least one colored zone is located in the optical path, when the multi-colored zone element 100 is switched into the light beam. That is, when one colored zone A is switched into the light beam, another colored zone B adjacent to the colored zone A can also be located in the light beam simultaneously.

However, it should be conceivable that in other embodiments, only one colored zone is located in the optical path, when the multi-colored zone element 100 is switched into the light beam. That is, when one colored zone A is switched into the light beam, another colored zone B adjacent to the colored zone A has been completely switched out of the light beam.

More preferable, at least two colored zones are simultaneously located in the light beam, when the multi-colored zone element 100 completely intercepts the light beam. This allows the projected light spots to present multiple colors simultaneously, thereby increasing color richness of the light spot effect.

In a particular embodiment, when the multi-colored zone element 100 completely intercepts the light beam, three colored zones are simultaneously located in the light beam.

In the context of the present disclosure, the multi-colored zone element 100 may include the colored zones of at least 6 colors. This increases color selectivity for the light spot effect.

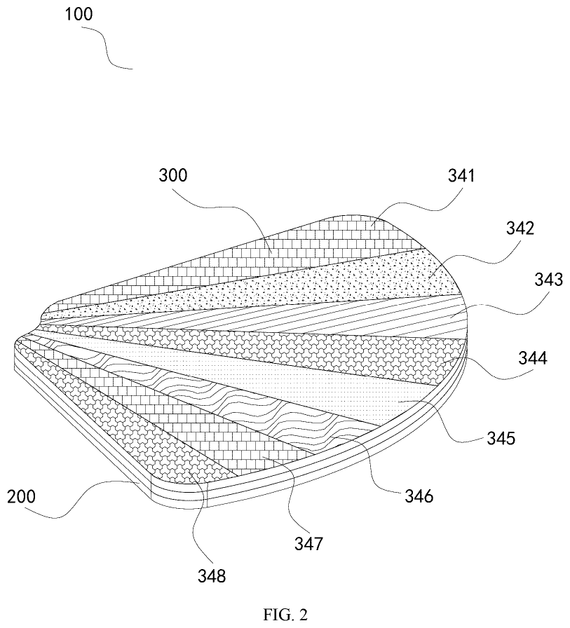

In this embodiment, as shown in FIG. 2, the multi-colored zone element 100 has colored zones of 8 colors.

In the context of the present disclosure, the multi-colored zone element 100 may include at least two transparent substrates 200 stacked on top of one another, and at least one side of each transparent substrate 200 is coated with a color coating layer 300.

In a more preferable embodiment of the present disclosure, the multi-colored zone element 100 may particularly include three transparent substrates 200 stacked on top of one another, and at least one side of each transparent substrate 200 is coated with a color coating layer 300.

As the dielectric film has good color stability and is not easy to fade, the color coating layer 300 may be a dielectric film.

The color coating layer 300 may be a metal film. The metal film is very suitable for the high-temperature environment inside the stage lighting fixture, due to its superior heat insulation performance and strong durability.

In the context of the present disclosure, the color of each of the color coating layers 300 may be one of cyan, magenta, and yellow, or one of red, green, and blue. The three primary colors of cyan, magenta, and yellow are based on subtractive color mixing, and the three primary colors of red, green, and blue are based on additive color mixing. The contrast between colors within each group of three primary colors is distinct, which can give the audience a strong visual impact.

More preferably, the color of each color coating layer 300 is one of cyan, magenta, and yellow.

Furthermore, in the emission direction of the light beam, at most two color coating layers 300 are overlapped simultaneously. This ensures that the color formed by the overlapped color coating layers 300 is precisely controllable, avoiding unpredictable colors caused by too many overlapped color coating layers 300, as well as simplifying color design and adjustment/replacement.

More preferably, one color coating layer 300 may be partially overlapped with other color coating layer 300. That is, the other part of the color coating layer 300 does not overlap with any other color coating layer 300, i.e., it overlaps directly with the transparent substrate 200, which can retain the original color, thereby providing a stronger visual impact.

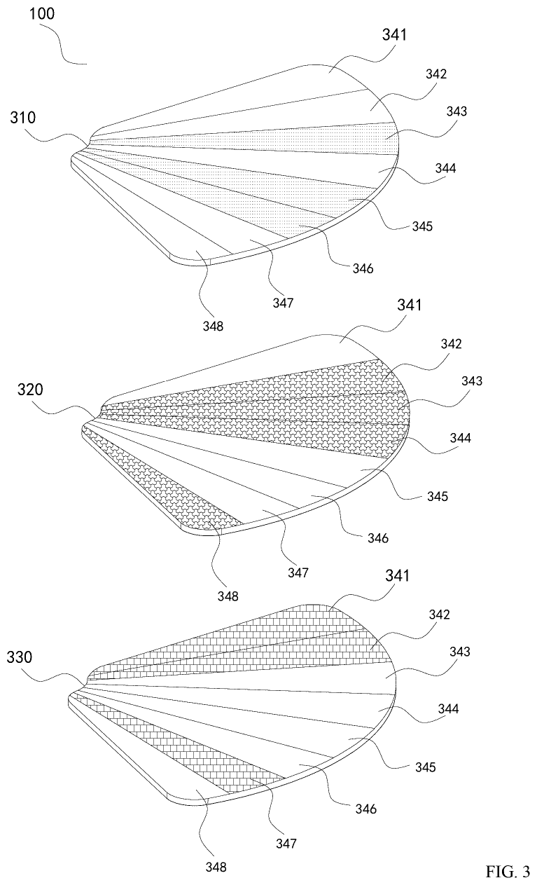

In this embodiment, the multi-colored zone element 100 includes three stacked transparent substrates 200 and at least one side of each transparent substrate 200 is coated with a color coating layer 300. As shown in FIG. 3, the three stacked color coating layers 300 include a first color coating layer 310, a second color coating layer 320, and a third color coating layer 330. The three color coating layers 300 are all divided into eight colored zones. The eight colored zones are indicated as a first zone 341, a second zone 342, a third zone 343, a fourth zone 344, a fifth zone 345, a sixth zone 346, a seventh zone 347, and an eighth zone 348.

The color distribution of the multi-colored zone element 100 from the first zone 341 to the eighth zone 348 are sequentially: yellow, red, dark blue, magenta, cyan, green, yellow, and magenta.

The color distribution of the three color coating layers 300 is described below.

In the first color coating layer 310, the third zone 343, the fifth zone 345, and the sixth zone 346 form the colored zones in cyan, and the first zone 341, the second zone 342, the fourth zone 344, the seventh zone 347, and the eighth zone 348 form the uncolored zones.

In the second color coating layer 320, the second zone 342, the third zone 343, the fourth zone 344, and the eighth zone 348 form the colored zones in magenta, and the first zone 341, the fifth zone 345, the sixth zone 346, and the seventh zone 347 form the uncolored zones.

In the third color coating layer 330, the first zone 341, the second zone 342, and the seventh zone 347 form the colored zones in yellow, and the third zone 343, the fourth zone 344, the fifth zone 345, the sixth zone 346, and the eighth zone 348 form the uncolored zones.

More preferable, in the emission direction of the light beam, each side of the transparent substrate 200 may be provided with the color coating layer 300. This reduces the number of pieces of the transparent substrate 200, thereby reducing the thickness of the multi-colored zone element 100, so that the color separations can be clearly imaged.

In a more particular embodiment of the present disclosure, the multi-colored zone element 100 includes three stacked transparent substrates 200, and a single side of each transparent substrate 200 is coated with a color coating layer 300. Three stacked transparent substrates 200 has appropriate thickness, and can also achieve sufficient colors.

Adjacent transparent substrates 200 in the present embodiment are fixed by adhesively bonding at edges. By fixing via adhesively bonding the edges, water ripples between the transparent substrates 200 will be not formed, which can effectively avoid the influence of adhesive on the light beam, resulting in better light efficiency.

More preferably, adjacent transparent substrates 200 are fixed by adhesively bonding edges at intervals. This way can release stress caused by thermal expansion during temperature rising of the transparent substrates 200 due to irradiation of the light beam, and thus avoid breakage of the transparent substrates 200 caused by the unreleased stress.

The color wheel may be provided with a plurality of multi-colored zone elements 100, and the first drive assembly 530 selectively drives one of the multi-colored zone elements 100 to switch into the light beam. This can provide more color arrangements, thus allowing for richer color choices. One multi-colored zone element 100 can be driven by the first drive assembly 530 to switch into the light beam according to actual demands.

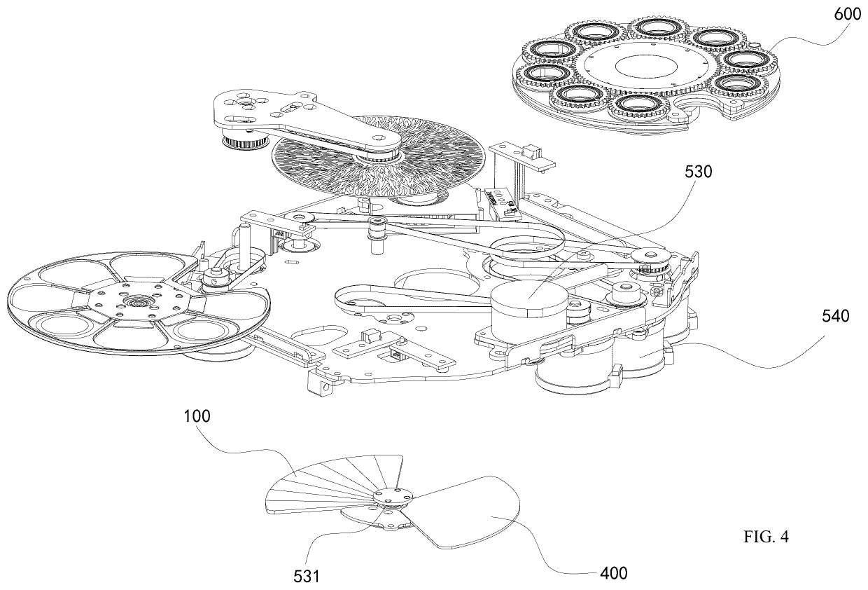

Referring to FIG. 4, the first drive assembly 530 in the present embodiment particularly includes a first motor and a transmission gear connected to a rotating shaft of the first motor. The color wheel further includes a pulley 531 connected to the transmission gear through a synchronous belt. The multi-colored zone element 100 is fixed to the pulley 531 by adhesive bonding.

The color wheel further includes a gradient color filter 400, and the first drive assembly 530 is configured to selectively drive the multi-colored zone element 100 or the gradient color filter 400 to switch into the light beam. This configuration provides more possibilities for color effect by switching the multi-colored zone element 100 or the gradient color filter 400 into the light beam during performance according to actual demands.

The multi-colored zone element 100 and the gradient color filter 400 are all fixed to the pulley 531 separately by adhesive bonding.

A pattern effect element 600, such as a gobo, is further included in the emission direction of the light beam. The pattern effect element 600 is driven by a second drive assembly 540 to switch into/out of the light beam to generate a superimposed light effect cooperated with the multi-colored zone element 100. This configuration can generate a pattern effect with multiple colors, forming more vivid pattern light spots.

The pattern effect element 600 may be rotatable.

Obviously, the above embodiments of the present disclosure are only examples for clearly illustrating the present disclosure, and are not intended to limit the implementation modes of the present disclosure. For those of ordinary skill in the art, other changes or variations in different forms can be made on the basis of the above description. It is unnecessary and impossible to list all implementation modes here. Any modifications, equivalent replacements, and improvements made within the spirit and principle of the present disclosure shall be included within the scope of protection of the claims of the present disclosure.

What is claimed is:

1. A stage light fixture having a multi-colored zone effect element, comprising a light head, the light head is provided with a light source for emitting a light beam along a light path, and a color wheel and a light output lens arranged sequentially along an emission direction of the light beam, wherein the color wheel is provided with a multi-colored zone element having a plurality of colored zones, with adjacent colored zones in gapless connection, and the color wheel is driven by a first drive assembly to allow at least one of the plurality of colored zones of the multi-colored zone element to selectively switch into/out of the light beam.

2. The stage light fixture according to claim 1, wherein the multi-colored zone element is configured to allow at least two of the plurality of colored zones to be always simultaneously located in the light beam, when completely intercepting the light beam.

3. The stage light fixture according to claim 1, wherein the plurality of colored zones contain at least 6 colors.

4. The stage light fixture according to claim 1, wherein the multi-colored zone element comprises at least two superimposed transparent substrates stacked on top of one another, and at least one side of each transparent substrate is coated with a color coating layer.

5. The stage light fixture according to claim 4, wherein a color of the color coating layer is one of cyan, magenta, and yellow.

6. The stage light fixture according to claim 4, wherein a color of the color coating layer is one of red, green, and blue.

7. The stage light fixture according to claim 4, wherein in the emission direction of the light beam, at most two color coating layers are overlapped.

8. The stage light fixture according to claim 4, wherein one color coating layer is partially overlapped with other color coating layer.

9. The stage light fixture according to claim 4, wherein along the emission direction of the light beam, each side of each transparent substrate is provided with the color coating layer.

10. The stage light fixture according to claim 4, wherein the multi-colored zone element comprises three superimposed transparent substrates stacked on top of one another, and a single side of each transparent substrate is provided with the color coating layer.

11. The stage light fixture according to claim 4, wherein adjacent transparent substrates are fixed by adhesively bonding edges thereof with adhesive.

12. The stage light fixture according to claim 1, wherein the color wheel is provided with a plurality of multi-colored zone elements, and the first drive assembly is configured to selectively drive one of the multi-colored zone elements to switch into the light beam.

13. The stage light fixture according to claim 1, wherein the color wheel further comprises a gradient color filter, and the first drive assembly is configured to selectively drive the multi-colored zone element or the gradient color filter to switch into the light beam.

14. The stage light fixture according to claim 1, further comprising a pattern effect element in the emission direction of the light beam, which is driven by a second drive assembly to switch into/out of the light beam to generate a superimposed light effect cooperated with the multi-colored zone element.

15. The stage light fixture according to claim 1, wherein at least two multi-colored zone elements are arranged along the emission direction of the light beam, and each multi-colored zone element is assigned with one first drive assembly for separately switching the corresponding multi-colored zone element into/out of the light beam.

16. The stage light fixture according to claim 15, wherein the at least two multi-colored zone elements are configured to simultaneously switch into the light beam, with the colored zones of each of the multi-colored zone elements at least partially overlapped.

17. The stage light fixture according to claim 15, wherein the at least two multi-colored zone elements are arranged coaxially, which are driven to rotate by the corresponding first drive assembly to switch into/out of the light beam.
